(19) United States
(12) Patent Application Publication
(10) Pub. No.: US 2025/0008403 A1
(43) Pub. Date: Jan. 2, 2025

(54) METHOD AND APPARATUS FOR RELATIONSHIP INFORMATION BASED TRAFFIC PREDICTION

(71) Applicant: Samsung Electronics Co., Ltd., Suwon-si (KR)

(72) Inventors: Yong Ren, Somerset, NJ (US); Xiaochuan Ma, Hillsborough, NJ (US); Han Wang, Allen, TX (US); Yan Xin, Princeton, NJ (US); Jianzhong Zhang, Dallas, TX (US)

(21) Appl. No.: 18/345,549

(22) Filed: Jun. 30, 2023

(51) Int. Cl. H04W 36/22

(52) U.S. Cl. CPC H04W 36/22

(57) ABSTRACT

A method includes generating relationship information representing spatial relationships between network elements in a wireless communication network. The method also includes dividing the relationship information into multiple communities of network elements, wherein network elements within each community have a higher correlation than network elements in different communities. The method also includes identifying, for a target network element, one or more community level key network elements and one or more local key network elements in the relationship information. The method also includes predicting traffic at the target network element using a temporal-spatial algorithm, wherein the temporal-spatial algorithm predicts the traffic based on temporal features derived from historical data and spatial features derived from the one or more community level key network elements and the one or more local key network elements.

### TECHNICAL FIELD

This disclosure relates generally to wireless communications systems. Embodiments of this disclosure relate to methods and apparatuses for relationship information based traffic prediction.

### BACKGROUND

Traditionally, network traffic prediction is associated with network planning and network optimization. The goal of this type of traffic prediction is to forecast long term traffic trends and design a network based on the predicted highest traffic volume. In this scenario, the network will maintain certain redundancy of its resources to provide good use experience continuously. However, this redundancy also increases the operation expense of network operators. As a result, there have been some attempts to balance network quality and operation costs through intelligent network operation. For example, during busy hours, with the help of accurate traffic prediction, operators can implement some advance adjustment to avoid network congestion by switching some users from busy cells to free cells.

### SUMMARY

Embodiments of the present disclosure provide methods and apparatuses for relationship information based traffic prediction.

In one embodiment, a method includes generating relationship information representing spatial relationships between network elements in a wireless communication network. The method also includes dividing the relationship information into multiple communities of network elements, wherein network elements within each community have a higher correlation than network elements in different communities. The method also includes identifying, for a target network element, one or more community level key network elements and one or more local key network elements in the relationship information. The method also includes predicting traffic at the target network element using a temporal-spatial algorithm, wherein the temporal-spatial algorithm predicts the traffic based on temporal features derived from historical data and spatial features derived from the one or more community level key network elements and the one or more local key network elements.

In another embodiment, a device includes a transceiver and a processor operably connected to the transceiver. The processor is configured to: generate relationship information representing spatial relationships between network elements in a wireless communication network; divide the relationship information into multiple communities of network elements, wherein network elements within each community have a higher correlation than network elements in different communities; identify, for a target network element, one or more community level key network elements and one or more local key network elements in the relationship information; and predict traffic at the target network element using a temporal-spatial algorithm, wherein the temporal-spatial algorithm predicts the traffic based on temporal features derived from historical data and spatial features derived from the one or more community level key network elements and the one or more local key network elements.

In another embodiment, a non-transitory computer readable medium includes program code that, when executed by a processor of a device, causes the device to: generate relationship information representing spatial relationships between network elements in a wireless communication network; divide the relationship information into multiple communities of network elements, wherein network elements within each community have a higher correlation than network elements in different communities; identify, for a target network element, one or more community level key network elements and one or more local key network elements in the relationship information; and predict traffic at the target network element using a temporal-spatial algorithm, wherein the temporal-spatial algorithm predicts the traffic based on temporal features derived from historical data and spatial features derived from the one or more community level key network elements and the one or more local key network elements.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2 illustrates an example gNB according to various embodiments of the present disclosure;

FIG. 3 illustrates an example UE according to various embodiments of the present disclosure;

FIG. 4 illustrates an example structure of an intelligent operation system in which traffic prediction can be performed according to various embodiments of the present disclosure;

FIG. 5 illustrates an example process for relationship graph-based traffic prediction according to various embodiments of the present disclosure;

FIG. 6 illustrates an example NE relationship graph according to various embodiments of the present disclosure;

FIGS. 7A and 7B illustrate example relationship graphs at a sports stadium on a game day according to various embodiments of the present disclosure;

FIG. 8 illustrates an example process for building a PRG matrix according to various embodiments of the present disclosure;

FIG. 9 illustrates an example relationship graph with identified centralities, according to various embodiments of the present disclosure;

FIG. 10 illustrates an example process for selecting community-level key NEs according to various embodiments of the present disclosure;

FIG. 11 illustrates an example process for selecting local key NEs according to various embodiments of the present disclosure;

FIG. 12 illustrates an example structure of an MLP neural network according to various embodiments of the present disclosure;

FIG. 13 illustrates an example structure of a GCN and transformer based neural network according to various embodiments of the present disclosure; and

FIG. 14 illustrates a flow chart of a method for relationship graph-based traffic prediction according to various embodiments of the present disclosure.

### DETAILED DESCRIPTION

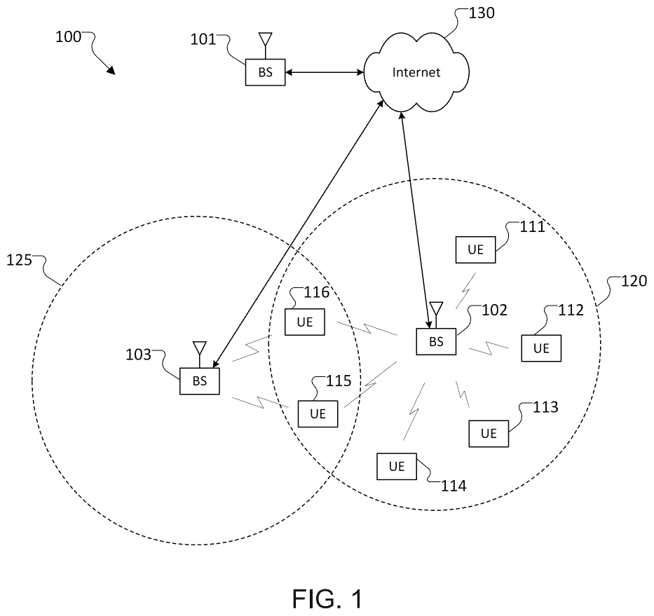

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programming, or a combination thereof for performing relationship graph based traffic prediction. In certain embodiments, one or more of the gNBs 101-103 includes circuitry, programming, or a combination thereof for performing relationship graph based traffic prediction.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

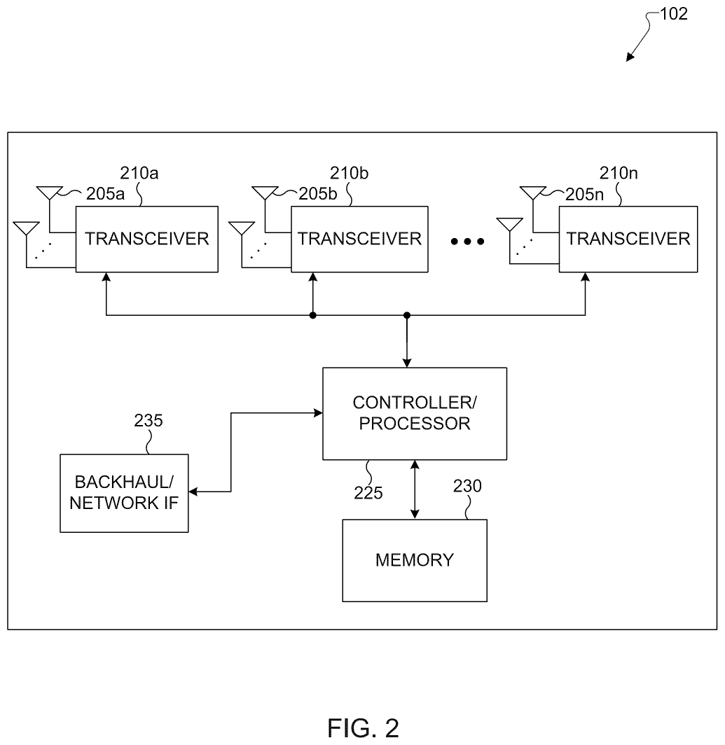

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support relationship graph based traffic prediction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

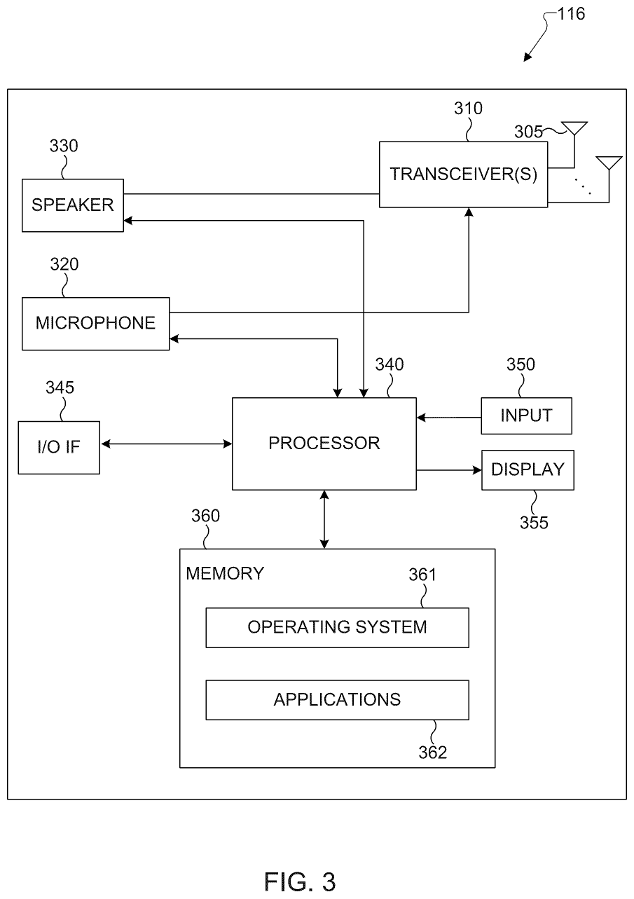

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for relationship graph based traffic prediction. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 (which includes for example, a touchscreen, keypad, etc.) and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

As discussed above, a goal of traffic prediction is to forecast long term traffic trends and design a network based on the predicted highest traffic volume. In this scenario, the network will maintain certain redundancy of its resources to provide good use experience continuously. However, this redundancy also increases the operation expense of network operators. As a result, there have been some attempts to balance network quality and operation costs through intelligent network operation. For example, during busy hours, with the help of accurate traffic prediction, operators can implement some advance adjustment to avoid network congestion by switching some users from busy cells to free cells. These attempts link traffic prediction to daily network operation. Unlike long term traffic prediction in network planning, short term prediction is more important in network operation. In 4G network, due to the lack of automatic adjustment mechanisms, the application and demand of intelligent network operation and accurate traffic prediction are limited.

With the arrival of the 5G era, cellular networks have become more complex and the data volume have increased significantly, which make network operations more complicated. Fortunately, SON, SDN, NFV and other new technologies embedded in 5G structures make intelligent network operation achievable. Traffic prediction plays an important role in many functions of intelligent network operation. For example, in dynamic resource allocation, accurate traffic prediction helps operators to schedule resources to maintain the overall quality of service and network performance while keeping equipment costs low. In network slicing, each virtual network or network slice can be adjusted based on the predicted traffic of different services. Another function traffic prediction can facilitate is energy saving. When the traffic demands of some cells are predicted to be low, these cells can be put to sleep to save energy.

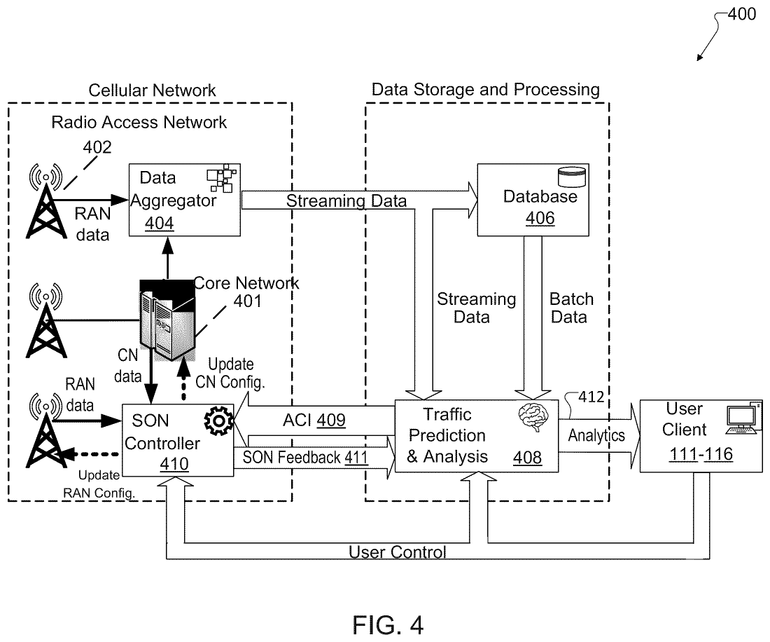

FIG. 4 illustrates an example structure of an intelligent operation system 400 in which traffic prediction can be performed according to embodiments of the present disclosure. The system 400 may be implemented on one or more servers, workstations, or other suitable electronic devices, which include the same or similar electronic components as UE 116. The data source is the cellular network infrastructure, including the Core Network (CN) 401 and the Radio Access Network (RAN) 402. RAN data may include measurements, metrics and other data collected from base stations (e.g., the gNBs 101-103) and UE devices (e.g., the UEs 111-116). Data from the CN 401 and the RAN 402 may be collected and aggregated at one or more intermediate nodes 404, which may be referred to as data aggregators, element management systems (EMS), or LTE management systems (LMS). The data may include performance measurement (PM) data such as KQIs/KPIs, counters, or metrics, which may be in the form of structured time series data or as unstructured data, such as log files. Fault management (FM) data may also be included, such as alarms events indicating a device failure or error state has occurred in the network. Moreover, configuration management (CM) data may be included, such as a log of configuration changes including timestamps and IDs of the network devices with before and after parameter values.

Network data from the data aggregator 404 may be transferred and stored in a database 406. Batches of historical data can then be retrieved from the database 406 by a prediction and analysis module 408, which processes the data to predict network traffic and performs analysis for energy saving, network slicing, resource allocation and other intelligent network operations. Data may also be streamed directly from the CN 401, the RAN 402, or the data aggregator 404 to the prediction and analysis module 408 for real-time processing. Further details on the prediction and analysis module 408 are provided later in this disclosure.

The prediction and analysis module 408 can perform computations on the input data and produce analytics and control information (ACI) 409, which may then be sent to one or more SON controllers 410. Note that the prediction and analysis module 408, along with the SON controller 410, may be hosted at a data center or local central office near the RAN 402, or may be collocated with a BS (e.g., the gNB 101-103). SON controllers 410 use the ACI 409 from the prediction and analysis module 408 to automatically perform actions on the network such as updating the configuration of one or more network elements. The prediction and analysis module 408 can also specify in the ACI 409 which devices or variables are of interest for the SON controller 410 to monitor. This may provide for more efficient operations as the SON controller 410 may be configured to only monitor a subset of network devices and data variables, instead of all possible variables. SON controllers 410 may also provide feedback messages 411 to the prediction and analysis module 408 about the state of the monitored devices and variables, so that the prediction and analysis module 408 can quickly adapt to changing network conditions and provide updated ACI 409 to the SON controllers 410.

Analytics information 412 generated by the prediction and analysis module 408 may be transmitted to a user client (e.g., the UE 111-116) for analysis by a network operation engineer in user client information (UCI) messages. The user client 111-116 can display the analytics information 412 in a user interface. Additionally, the user interface may accept commands from the user, which may be sent to the SON controller 410 or directly to the network elements to perform an action, such as a configuration update. Commands or feedback may also be sent by the user to the prediction and analysis module 408. This feedback may be used by the prediction and analysis module 408 to adjust its analysis results.

Although traffic prediction, especially short-term traffic prediction, becomes an important component in 5G intelligent operation, there are still many challenges to generate accurate predictions. Conventional methods use time series algorithms to predict network traffic. The most common methods are Auto Regression Integrated Moving Average (ARIMA) and long short-term memory (LSTM). While these types of algorithms provide reasonable results for long term network traffic prediction, they have some shortcomings for cell level short term prediction. For example, ARIMA cannot predict rapid traffic change since it only calculates the mean value of historical data. Furthermore, these methods have a major drawback that they cannot process spatial dependencies between cells. Short term cell traffic change may be impacted by many factors such as local trend, user mobility, weather, events, and the like. Among these factors, local trend can be modeled by a time series algorithm, while user mobility cannot. Spatial dependencies between cells can capture the movement and further increase the accuracy of traffic prediction.

Some algorithms try to utilize spatial dependencies to improve prediction performance. One conventional method divides an area of interest into small grids and aggregates the traffic of all cells in the same grid. Then a center grid and its neighbor grids are used as input to a convolutional neural network (CNN) to predict the traffic of the center grid. Such grid-based methods have better performance compared to time series methods due to added spatial information. However, the grid-based methods cannot predict cell level traffic directly, and they also cannot handle spatial dependency of long distance. In general, there are at least three challenges for utilizing spatial information to predict traffic of network elements (NEs): (i) How to explicitly describe the relationships and spatial dependency between NEs, (ii) how to include both local and global neighbors for prediction, and (iii) how to develop algorithms that can handle both temporal and spatial information.

To address these and other issues, this disclosure provides methods and apparatuses for relationship graph based traffic prediction. The disclosed embodiments are suitable for different levels of network elements, such as cell level, eNodeB level, etc. By utilizing graph theory and neural network algorithms, the disclosed embodiments are able to combine both temporal information and spatial information.

The disclosed embodiments include multiple features, including a logical relationship graph for NEs in a network. The graph describes the spatial dependency between NEs. The disclosed embodiments also feature an automatic community discovery that splits the global relationship graph into several local clusters. NEs within a local community may have high correlations, while NEs between communities may have low correlations. The disclosed embodiments also feature multi-level key NE identification, in which global key NEs and local key NEs are automatically identified. Two level key NEs will be used to predict the traffic of target NEs. The multi-level key NE identification component tries to ensure the global and the local spatial information will be included. The disclosed embodiments also feature a temporal/spatial (TS) prediction algorithm that can combine both temporal and spatial information. In the following sections, these features are described in more detail.

Note that while some of the embodiments discussed below are described in the context of 5G systems, these are merely examples. It will be understood that the principles of this disclosure may be implemented in any number of other suitable contexts or systems, including 6G and other systems.

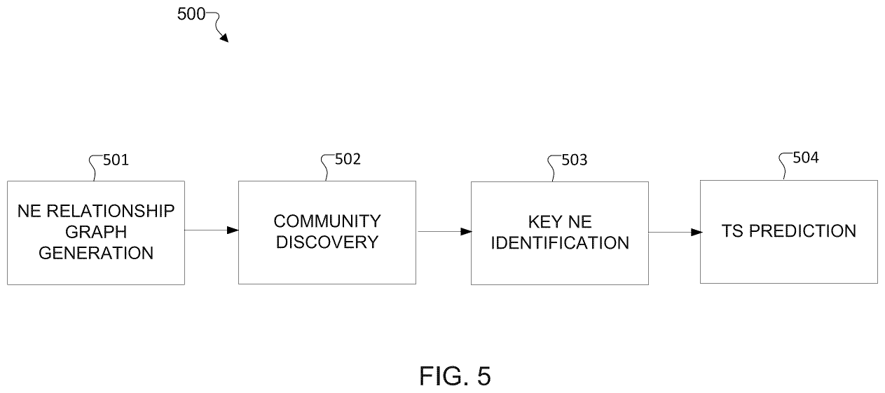

FIG. 5 illustrates an example process 500 for relationship graph-based traffic prediction according to various embodiments of the present disclosure. The embodiment of the process 500 shown in FIG. 5 is for illustration only. Other embodiments of the process 500 could be used without departing from the scope of this disclosure. For ease of explanation, the process 500 will be described as being implemented in the gNB 102 of FIG. 1. However, the process 500 could be implemented in any other suitable device.

As shown in FIG. 5, the process 500 includes a NE relationship graph generation operation 501, a community discovery operation 502, a key NE identification operation 503, and a temporal/spatial (TS) prediction operation 504, each of which is explained in greater detail below.

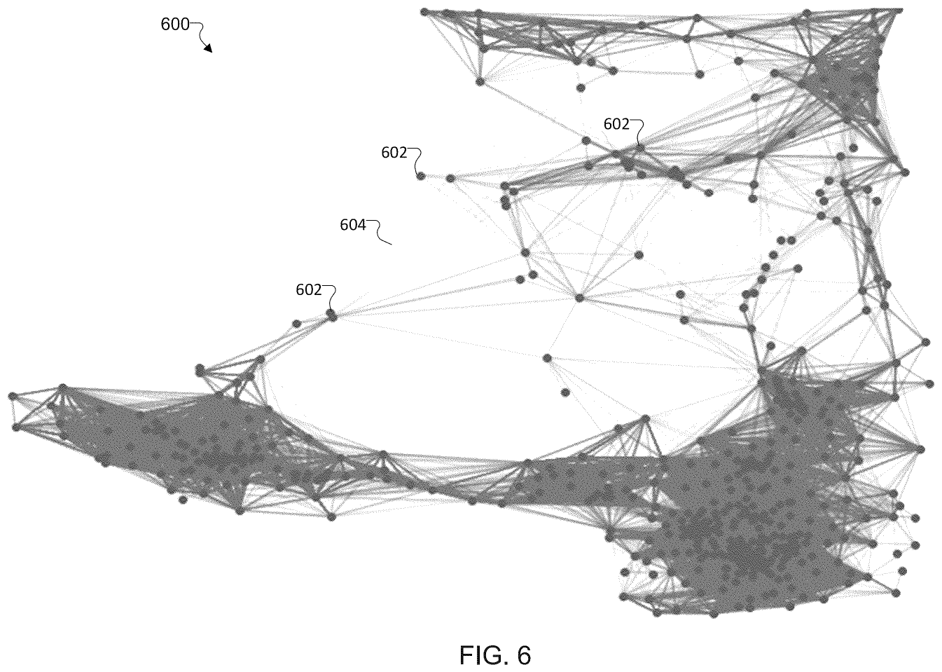

In the NE relationship graph generation operation 501, the gNB 102 generates a relationship graph representing relationships between NEs in a wireless communication network (e.g., the wireless network 100). In this disclosure, the spatial information of a network can be introduced by a relationship graph of the NE. For example, FIG. 6 illustrates an example NE relationship graph 600 according to various embodiments of the present disclosure. As shown in FIG. 6, the relationship graph 600 is an adjacency relationship graph that includes multiple (e.g., dozens, hundreds, thousands, or more) nodes 602, each representing a NE of the network. In some embodiments, the nodes 602 in the relationship graph 600 can represent all NEs in a whole market. The nodes 602 are connected by edges 604, which represent relationships between connected NEs. From the relationship graph 600, it can be seen how the NEs are related to each other and which neighbor would be more important for traffic prediction of a selected target NE.

In the graph generation operation 501, the gNB 102 can generate the relationship graph 600. For example, the relationship graph 600 can use the binary connection state between two nodes 602 (i.e., NEs) as a weight associated with the corresponding edge(s) 604. The binary connection state between two nodes 602 can be determined using handover data. In some embodiments, the binary connection state h_{i,j} between two nodes i and j can be expressed as follows:

$${h}_{i , j} = \{ \begin{matrix}0 , if {N}_{A 3 , i , j} + {N}_{A 5 , i , j} = 0 \\ 1 , if {N}_{A 3 , i , j} + {N}_{A 5 , i , j} \neq 0\end{matrix}$$

where N_{A3,i,j} and N_{A5,i,j} are the A3 and A5 handover events happened from NE i to NE j. As known in the art, the A3 and A5 handover events are standard LTE events. Other LTE events include A1, A2, A4, B1, and B2. While the embodiments described herein use A3 and A5 events, other LTE events could be used, and are within the scope of this disclosure.

Different metrics can be used as edge weights in the relationship graph 600. For example, handovers between NEs, adjacency relationships, Pearson correlation coefficients between the traffic variations of NEs, and the like, can be used for metrics. These metrics can measure different kind of connections between the NEs. The following details two different techniques for building the relationship graph 600 in the graph generation operation 501.

### Technique 1: Handover-Based Relationship Graph.

In this technique, the relationship graph 600 is a handover-based relationship graph, in which the number of handovers that occur between two NEs (i.e., two nodes 602) are used as the weights of the corresponding edges 604. In some embodiments, the gNB 102 can generate the handover-based relationship graph as follows.

Step 1: Extract the handover data, including A3 and A5 handover events, from the PM dataset associated with the network.

Step 2: Clean the data. Specifically, remove the missing values, i.e., “NA” and “NaN” values, from the handover data.

Step 3: Calculate the flow of handovers between NEs using A3 and A5 handover events. Concretely, the handover-based relationship between NE i and j during time period Tₖ are calculated as follows:

$${h}_{i , j , k} = {N}_{A 3 , i , j , k} + {N}_{A 5 , i , j , k} - {N}_{A 3 , j , i , k} - {N}_{A 5 , j , i , k}$$

where N_{A3,i,j,k} and N_{A5,i,j,k} are the number of A3 and A5 handover events that occurred from NE i to NE j during time period Tₖ, and N_{A3,j,i,k} and N_{A5,j,i,k} are the number of A3 and A5 handover events that occurred from NE j to NE i during time period Tₖ.

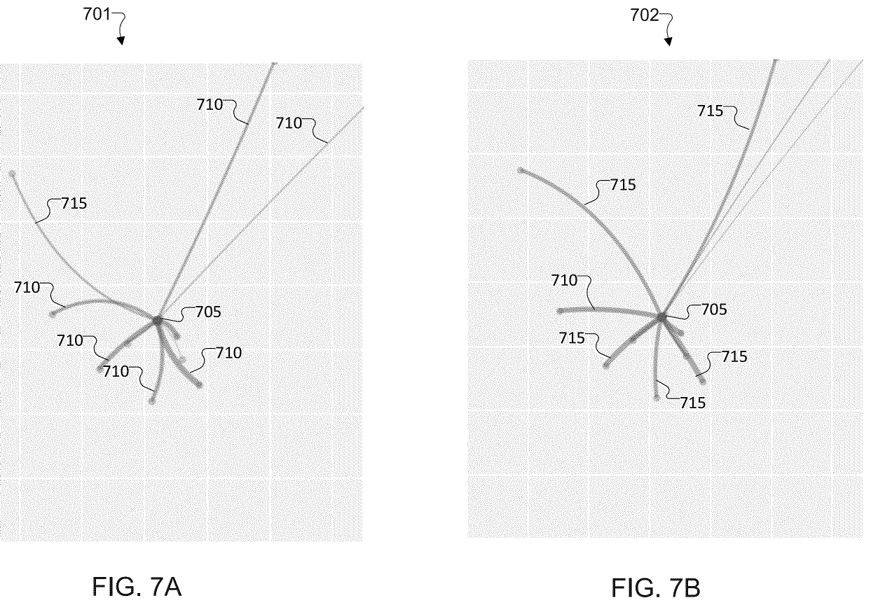

Therefore, the handover-based relationship graph during time period Tₖ can be expressed as a matrix H_{i,j,k} with h_{i,j,k} as its elements. With different period length Tₖ, the handover-based relationship matrix can be used to express long-term (e.g., week or day level) and short-term (e.g., hour or minute level) relationships. FIGS. 7A and 7B illustrate example relationship graphs 701 and 702 at a sports stadium on a game day according to various embodiments of the present disclosure. The node 705 in the graphs 701 and 702 represents the NE at the stadium. As shown in FIG. 7A, the graph 701 reflects communication 30 minutes before the start of the game. In FIG. 7B, the graph 702 reflects communication 15 minutes after the game ends. Some edges 715 indicate handover from the stadium to other NEs, while other edges 710 indicate handover from other NEs to the stadium. These short-term handover-based relationship graphs are consistent with the time line of the event, and can be used help predict traffic.

### Technique 2: PRG-based Relationship Graph.

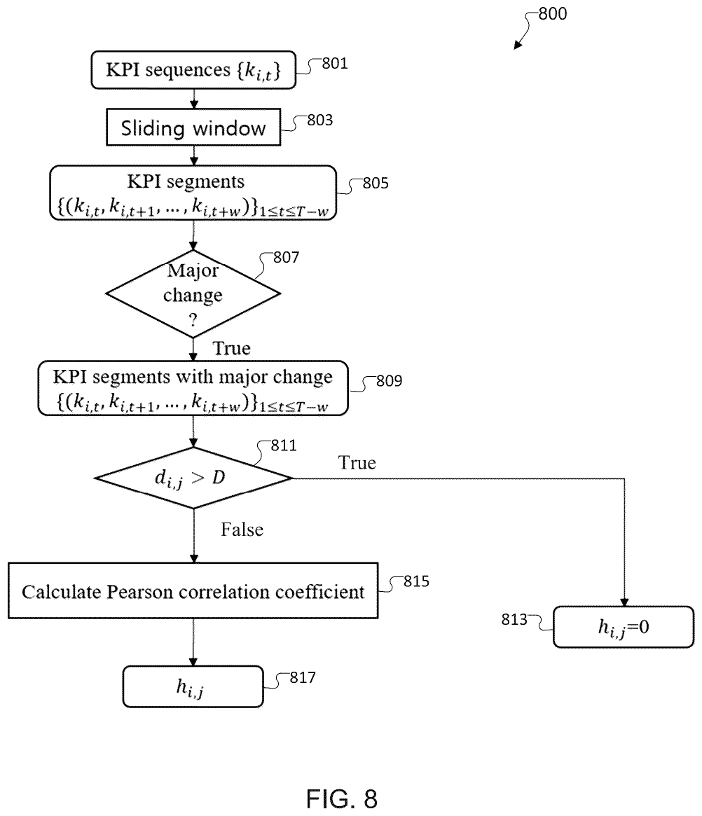

Pearson correlation coefficients are another metric that can be used as the weights in the relationship graph. In the Pearson correlation coefficient relationship graph (PRG), Pearson correlation coefficients between the traffic variations of different NEs can be used as the edge weights. There are many possible ways to calculate elements in a PRG matrix. As an example, FIG. 8 illustrates an example process 800 for building a PRG matrix according to various embodiments of the present disclosure.

As shown in FIG. 8, the process 800 begins at step 801, in which KPI sequences {k_{i,t}} are determined. Let {k_{i,t}}_{1≤t≤T} and {k_{j,t}}_{0<t≤T} denote the traffic data sequences of the NE i and j. At step 803, a sliding window with width w is applied to sequence {k_{i,t}}_{1≤t≤T}. This results in a dataset of w-long KPI segments, {(k_{i,t}, k_{i,t+1}, . . . , k_{i,t+w})}_{1≤t≤T-w}, such as indicated at 805.

At step 807, the KPI segments in the sequence with major changes are selected. In some embodiments, a KPI segment (k_{i,t}, k_{i,t+1}, . . . , k_{i,t+w}) can be identified as a segment with major change if

$${\sum }_{n = t}^{t + w} \vert {k}_{i , n} - \frac{1}{w} {\sum }_{m = t}^{t + w} {k}_{i , m} \vert \geq σ$$

where σ is a threshold we can select for different datasets. The recommendation value is the standard deviation of all data samples in the sequence {k_{i,t}}_{1≤t≤T}. Finally, the segments with major changes are collected and form a data set {(k_{iτ}, k_{i,τ+1}, . . . , k_{i,τ+w})}_{τ∈T}_{_{c}}, where T_{c}={1≤t≤T−w|(k_{i,t}, k_{i,t+1}, . . . , k_{i,t+w}) is a segment with major change}. The KPI segments with major change are indicated at 809.

At step 811, the physical distance d(i,j) between NE i and j is calculated and compared to a threshold distance D. If d(i,j) is greater the threshold distance D, then at step 813, set h_{i,j}=0. In other words, if two NEs are far away from each other, it is assumed that the two NEs do not have a strong relationship. This technique can considerably reduce the computational complexity.

Alternatively, if d(i,j)<D, for each τ∈T_{c}, then the process 800 moves to step 815 where the Pearson correlation coefficients are calculated between the following N segment pairs (1). (k_{i,τ}, k_{i,τ+1}, . . . , k_{i,τ+w}) and (k_{j,τ-1}, k_{j,τ}, . . . , k_{j,τ-1+w}); (2). (k_{i,τ}, k_{i,τ+1}, . . . , k_{i,τ+w}) and (k_{j,τ-2}, k_{j,τ-1}, . . . , k_{j,τ-2+w}); . . . (N). (k_{i,τ}, k_{i,τ+1}, . . . , k_{i,τ+w}) and (k_{j,τ-N}, k_{j,τ-N+1}, . . . , k_{j,τ-N+w}) Then N Pearson correlation coefficients can be acquired. Then take the absolute value of all the Pearson correlation coefficients. After repeating this procedure for all τ∈T_{c}, there are N Pearson correlation coefficients lists. The m th list includes the Pearson correlation coefficients between (k_{i,τ}, k_{i,τ+1}, . . . , k_{i,τ+w}) and (k_{j,τ-m}, k_{j,τ-m+1}, . . . , k_{j,τ-m+w}) for all τ∈T_{c}. Taking the mean value for each list results in N scalars. Finally, the maximum value in the N scalars is selected to be h_{i,j}, as indicated at 817. In some embodiments, the techniques to summarize all these Pearson correlation coefficients can be changed based on different applications.

By repeating the process 800 for every NE pair (i,j), the PRG matrix can be obtained.

### Community Discovery Operation 502.

The NE relationship graph generation operation 501 results in a relationship graph that describes the correlations of all NEs in a network, such as the relationship graph 600 of FIG. 6. As shown in FIG. 6, if the network contains a lot of NEs, the graph can become very large and very complicated. One benefit of the original global graph is that the overall information of a network can be obtained, for example, what the whole network looks like, where the dense area(s) are located, where the sparse area(s) are located, and the like. In terms of further analysis for NEs, the network level graph can help to identify the most important NEs in the global level.

However, based on the analysis, although some NEs (especially the globally important NEs) may have long-range influence to other NEs, the influence will decrease when distance between NEs increase. Moreover, the large size of a graph can increase the computation cost when used as an input to a neural network. To address this issue, the gNB 102 can perform the community discovery operation 502, which is an automatic multi-layer community discovery algorithm to divide the global graph into smaller units for further analysis. The community discovery operation 502 is performed to find the community structures in a graph in which nodes are tightly connected within communities and loosely connected between communities. Community detection can be considered as a special type of clustering, but is tailored to use in graph partition, which depends on a single feature—edges. NEs that have been grouped into the same community may have strong interactions among the group. They may also have similar behaviors and have strong influence to each other.

In some embodiments, the global relationship graph 600 is used as input to the community discovery operation 502. In some embodiments, the global relationship graph 600 can be further divided into market level, sub-market level, and local level graphs. Local level graphs can contain a certain number of NEs and can be used as input for other modules in the traffic prediction process 500. The gNB 102 can perform the community discovery operation 502 as described below:

Step 1: Define the appropriate size of a community N, which indicates the number of NEs in a community. Define a ratio of qualified community R, which is the number of communities that have less than N NEs over the total number of communities. Define the maximum ratio of qualified community Rₘₐₓ.

Step 2: Use a Louvain algorithm or other similar algorithm to divide the global relationship graph 600 into several small communities.

Step 3: Check if R is less than Rₘₐₓ. If true, repeat step 2. If false, stop the process.

### Key NE Identification Operation 503.

As an important additional information source for the traffic prediction task, the gNB 102 can select the key neighbor NEs for traffic prediction of the target NE. For the prediction task, two types of information should be considered: (i) the direct or indirect neighbor NEs which show correlation with the target NE, and (ii) the key NE in the community. The direct or indirect neighbor NEs which show correlation with the target NE-referred to as the local key NEs—can provide the information about how the traffic will change at the target NE. On the other hand, the key NEs of the community that includes the target NE can provide information about the status of the whole community. Both of these two information sources are considered important for the traffic prediction task. The gNB 102 can perform the key NE identification operation 503 to select these two kinds of key NEs, the community-level key NEs and local key NEs.

Community-level key NEs are the key NEs selected in the NE community that the target NE belongs to. Community-level key NEs provide the information of the traffic in community level, which can help the traffic prediction task. There are many possible ways to select key NEs in a community. For example, the gNB 102 can use centrality techniques to evaluate the importance of the NEs in the community. Based on different application scenarios, the gNB 102 can use different type of centralities, such as degree centrality, betweenness centrality, closeness centrality, and PageRank centrality. These will now be described.

Degree centrality: In the cellular traffic graph, the degree centrality can be measured by the number of handovers among the NEs. Based on the A3 and A5 event data, the in-degree and out-degree can be calculated. Concretely, the in-degree is the number of handovers from other NEs to the target NE, while the out-degree is the number of handovers from the target NE to other NEs.

Betweenness centrality: From the handover data, the adjacency relationship among all NEs in the community can be built. Then using an algorithm for the shortest path problem (e.g., Dijkstra's algorithm), the shortest path between any two NEs in the target community can be determined. With the shortest path results, betweenness centrality can calculated as:

$${C}_{B} ( i ) = {\sum }_{s \neq i , t \neq i} {n}_{i} ( s , t )$$

where nᵢ(s, t) is the number of shortest paths from s to t that pass through i.

Closeness centrality: The closeness centrality can be calculated as:

$${C}_{C} ( i ) = \frac{n - 1}{{\sum }_{j \neq i} dist ( i , j )}$$

where dist(i,j) is the distance (in the graph) from NE i and j and n is the number of nodes in the network.

PageRank centrality: For a graph (V, E), let A:=(aᵢⱼ) be the adjacency matrix and dⱼ^{out}=Σ_{j∈V}aᵢⱼ. Then the PageRank centrality is defined as:

$$PR ( i ) = γ {\sum }_{j ∈ V} \frac{{a}_{ji}}{{d}_{j}^{out}} PR ( j ) + \frac{1 - γ}{n}$$

where PR(i) is the PageRank centrality of node i, and n=|V| is the number of nodes of the graph.

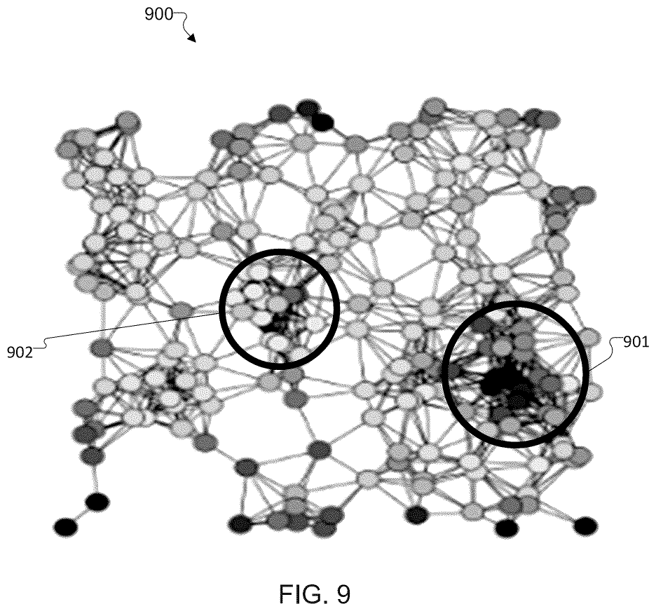

Based on given data set about the network traffic, the gNB 102 can calculate the centralities of the NEs in the community. FIG. 9 illustrates an example relationship graph 900 with identified centralities, according to various embodiments of the present disclosure. As shown in FIG. 9, the graph 900 includes various nodes representing NEs within the circles 901 and 902. The NEs with high importance, which are shaded darker in the circles 901 and 902, can be identified as the community-level key NEs and can be used in the following prediction methods to help improve the prediction accuracy.

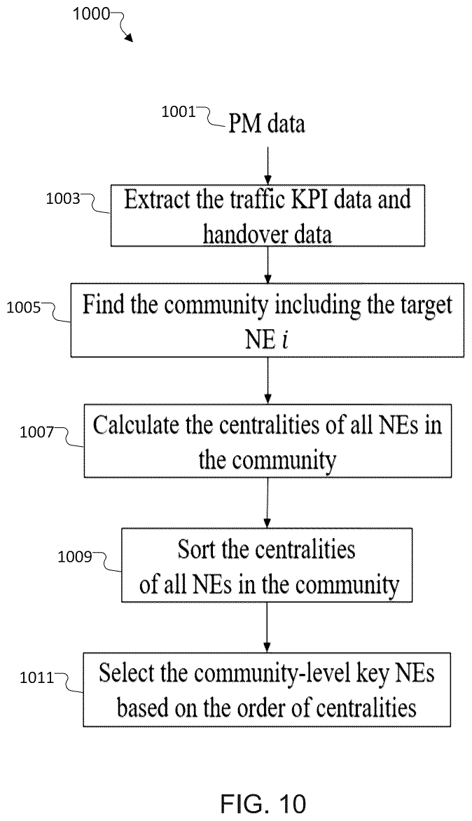

FIG. 10 illustrates an example process 1000 for selecting community-level key NEs according to various embodiments of the present disclosure. As shown in FIG. 10, the process 1000 starts with an input of performance measurement (PM) data 1001. At operation 1003, the gNB 102 extracts traffic KPI data and handover data from the PM data 1001. At operation 1005, the gNB 102 determines the community that includes the target NE (such as by performing the community discovery operation 502). At operation 1007, the gNB 102 calculates the centralities of all NEs in the community (such as using one of the centrality techniques described above). At operation 1009, the gNB 102 sorts the centralities of all NEs in the community, and at operation 1011, the gNB 102 selects the community-level key NEs based on the sorted order of the centralities (such as by selecting x NEs at the top of the sorted order).

Local key NEs are defined as the NEs that can provide important information for the traffic prediction of the target NE. The handover-based relationship graph and the PRG can be used to identify the NEs. For example, assume the gNB 102 is trying to identify the local key NEs for NE i using the handover-based relationship graph. The handover-based relationship graph can include the absolute traffic flow from all the neighbors of NE i to the target NE i during a long time period Tₖ, h_{i,j,k}. In this case, a NE is a local key NE if h_{i,j,k}>h where h is a predetermined threshold. The selection of h depends on the statistic traffic around the target NE i. Typically, h is taken as 5% of the total traffic flow at NE i in time period Tₖ.

An alternative way to identify the local key NE is to use the PRG. The elements in the PRG, h_{i,j}, represent the correlation between the variation trend between the NE pair i and j. Based on this PRG matrix, the correlation between the target NE i and all other NEs can be ranked. Finally, the NEs having high rank will be identified as the local key NEs.

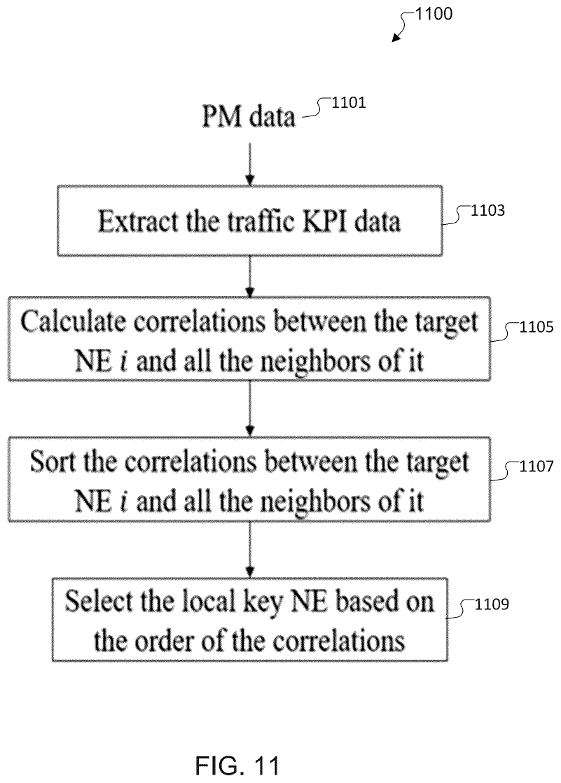

FIG. 11 illustrates an example process 1100 for selecting local key NEs according to various embodiments of the present disclosure. As shown in FIG. 11, the process 1100 starts with an input of PM data 1101. At operation 1103, the gNB 102 extracts traffic KPI data from the PM data 1101. At operation 1105, the gNB 102 calculates correlations between the target NE and all of its neighbors (such as using one of the correlation techniques described above). At operation 1107, the gNB 102 sorts the calculated correlations, and at operation 1109, the gNB 102 selects the local key NEs based on the sorted order of the correlations (such as by selecting x NEs at the top of the sorted order).

### TS Prediction Operation 504.

In this disclosure, multiple cellular traffic prediction models are described, which can be used in the TS prediction operation 504. The traffic prediction models include the sliding-window multi-layer perceptron (MLP)-based traffic prediction model and the graph convolutional neural network (GCN) and transformer-based prediction model. These models capture temporal features from the historical data, and capture spatial features from the relationship graph. Applying the information obtained from the traffic data of the key NEs and the handover data between the key NEs and the target NE, these models can be used in the prediction of many traffic KPIs, such as active user number, traffic throughput rate, traffic throughput volume, etc. In the examples below, the procedures of the prediction for the active user number are described.

### Sliding-Window MLP-Based Cellular Traffic Prediction Model.

For this model, suppose the historical active user number data samples of NE at location I and time t is Sₗ={(x_{1,l}, x_{2,l}, . . . , x_{t,l})}, and the gNB 102 wants to predict the active user number of the NE i. The sliding-window MLP-based traffic prediction model includes the following steps:

Step 1: Initialize the width of the sliding window w and the threshold σ. Then build the PRG following the steps described earlier.

Step 2: Find the NE community that includes the target NE i, then calculate the degree centrality for all NEs in this community.

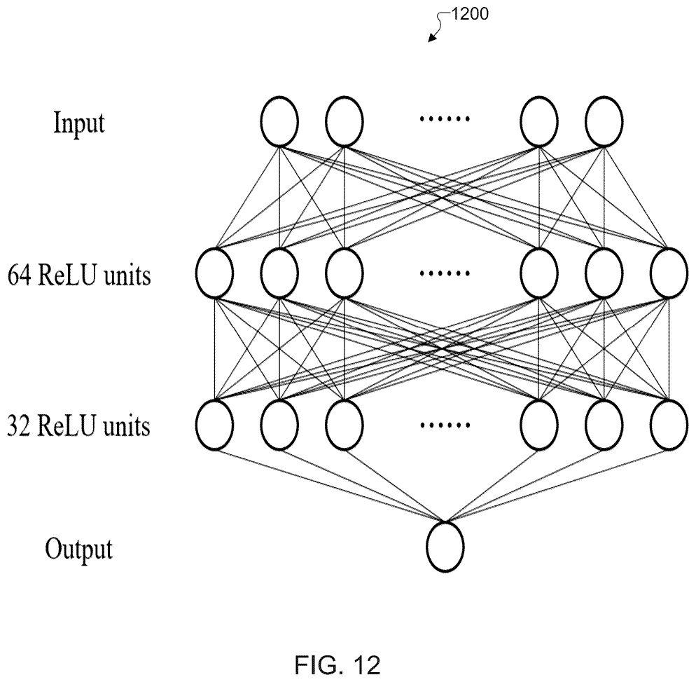

Step 3: Initialize parameters for the prediction model, including the input size dᵢₙₚᵤₜ and the structure of the neural network. In some embodiments, the prediction model can use an MLP neural network. FIG. 12 illustrates an example structure of an MLP neural network 1200 according to various embodiments of the present disclosure.

Step 4: Since the input size of the neural network is dᵢₙₚᵤₜ, the total number of the community-level key NEs and the local key NEs needed for the input to the neural network is dᵢₙₚᵤₜ−1. Initialize the number of the community-level key NEs and the local key NEs as:

$${d}_{community} = ⌈ \frac{{d}_{input} - 1}{2} ⌉ ,$$

$${d}_{local} = {d}_{input} - 1 - {d}_{community} .$$

Then identify the community-level key NEs and the local key NEs based on the degree centrality for all NEs in this community and the PRG, respectively. Select the d_{community} NEs with the highest degree centralities in the community as the community-level key NEs. Select the d_{community} NEs with the highest correlations in the PRG as the local key NEs. If there exists overlap NEs between the community-level key NEs and the local key NEs, take additional NEs with high degree centralities or correlations in the PRG to make up the number of overlap NEs in the input of the neural network.

Step 5: Select the data samples of the target NE, the community-level key NEs, and the local key NEs. Then summarize them together as {\vec{x₁}, \vec{x₂}, . . . , \vec{xₜ}}. Here \vec{xₜ} is the dᵢₙₚᵤₜ dimensional vector of the active user number at time unit t for the target NE, the community-level key NEs, and the local key NEs.

Step 6: Apply a sliding window to the {\vec{x₁}, \vec{x₂}, . . . , \vec{xₜ}}. This results in a dataset (X, Y) as follows:

$$\{ \begin{matrix}X = {\{ ( \vec{{x}_{t - W + 1}} , \vec{{x}_{t - W + 2}} , … , \vec{{x}_{t}} ) \}}_{t \geq 1} \\ Y = {\{ {x}_{t + 1 , i} \}}_{t \geq 1}\end{matrix} .$$

Note that for t≤0, the elements of \vec{xₜ} are all zero. Afterwards, the dataset (X, Y) is divided into the training set (Xₜᵣₐᵢₙ, Yₜᵣₐᵢₙ), the validation set (Xᵥₐₗ, Yᵥₐₗ), and the test set (Xₜₑₛₜ, Yₜₑₛₜ).

Step 7: Train the neural network with the training set (Xₜᵣₐᵢₙ, Yₜᵣₐᵢₙ) and keep monitoring the mean square error on (Xᵥₐₗ, Yᵥₐₗ). Stop training when the mean square error (MSE) on (Xᵥₐₗ, Yᵥₐₗ) stops decreasing.

Step 8: Predict the active user number for the test data set Xₜₑₛₜ. Then compute the MSE of the neural network on the test set (Xₜₑₛₜ, Yₜₑₛₜ).

Step 9: The hyper parameters in this prediction model include the PRG sliding window w, the PRG threshold σ, d_{community}, structure of the neural network, and width of the prediction sliding window W. Tune these hyper parameters and repeat the previous steps to find the optimal hyper parameters that correspond to the lowest mean square error on the test set (Xₜₑₛₜ, Yₜₑₛₜ).

### GCN and Transformer Based Cellular Traffic Prediction Model.

Besides basic neural networks such as MLP, more advanced neural networks can be used in the cellular traffic prediction task to improve the prediction accuracy. By applying a graph convolutional neural network (GCN) and transformer, the GCN and Transformer based cellular traffic prediction model can include the following steps:

Step 1: Initialize the width of the sliding window w and the threshold σ. Then build the PRG following the steps following the steps described earlier.

Step 2: Find the NE community which includes the target NE i, then calculate the degree centrality for all NEs in this community.

Step 3: Extract the handover data of all NEs from the PM data. Then build the handover-based relationship graph and the adjacency relationship graph based on the handover data.

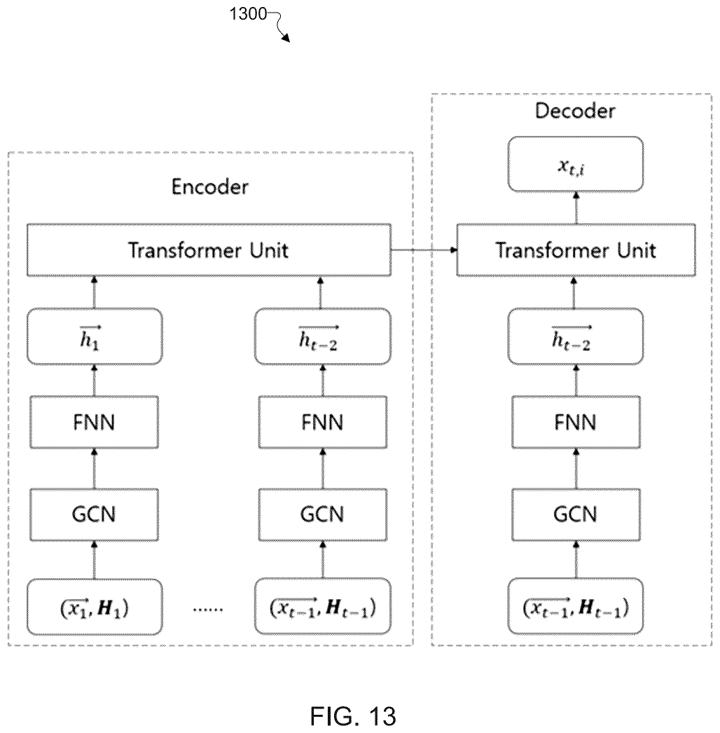

Step 4: Initialize parameters for the prediction model, including the input size dᵢₙₚᵤₜ and the structure of the neural network. In some embodiments, the prediction model can use a GCN and transformer based neural network. FIG. 13 illustrates an example structure of a GCN and transformer based neural network 1300 according to various embodiments of the present disclosure. In the figure, FNN denotes a feedforward neural network.

Step 5: Since the input size of the neural network is dᵢₙₚᵤₜ, the total number of the community-level key NEs and the local key NEs needed for the input of the neural network is dᵢₙₚᵤₜ−1. Initialize the number of the community-level key NEs and the local key NEs as;

$${d}_{community} = ⌈ \frac{{d}_{input} - 1}{2} ⌉ ,$$

$${d}_{local} = {d}_{input} - 1 - {d}_{community} .$$

Then identify the community-level key NEs and the local key NEs based on the degree centrality for all NEs in this community and the PRG, respectively. First, using the adjacency graph, select the candidate NEs that can reach the target NE i within k handover steps. Select the d_{community} NEs with the highest degree centralities from the candidate NEs as the community-level key NEs. Select the d_{community} NEs with the highest Pearson correlations from the candidate NEs as the local key NEs. If there exists overlap NEs between the community-level key NEs and the local key NEs, take additional NEs with high degree centralities or correlations in the PRG to make up the number of overlap NEs in the input of the neural network. The graph formed by the target NE, the community-level key NEs, and the local key NEs is denoted as (V, E). In this step, the number k can be adjusted according to dᵢₙₚᵤₜ.

Step 6: Select the data samples of the target NE, the community-level key NEs, and the local key NEs. Then summarize them together as {\vec{x₁}, \vec{x₂}, . . . , \vec{xₜ}}. Here \vec{xₜ} is the dᵢₙₚᵤₜ dimensional vector of the active user number at time unit t for the target NE, the community-level key NEs, and the local key NEs. Finally, create the data set (X, Y) as follows:

$$\{ \begin{matrix}X = {\{ \vec{{x}_{t}} \}}_{t \geq 1} \\ Y = {\{ {x}_{t + 1 , i} \}}_{t \geq 1}\end{matrix} .$$

Afterwards, divide the dataset (X, Y) into the training set (Xₜᵣₐᵢₙ, Yₜᵣₐᵢₙ), the validation set (Xᵥₐₗ, Yᵥₐₗ), and the test set (Xₜₑₛₜ, Yₜₑₛₜ). In addition, based on the handover data, build the normalized handover matrix of the target NE, the community-level key NEs, and the local key NEs, Hₜ for time unit t. The elements of Hₜ are calculated as:

$${H}_{i , j , t} = \frac{{h}_{i , j , t}}{{\sum }_{k ∈ E , k \neq i} {h}_{i , k , t}} ,$$

$$for$$

$$i \neq j$$

where h_{i,j,t} is the element in the handover-based relationship graph at time unit t.

Step 7: Build a GCN and transformer based model, such as the GCN and transformer based neural network 1300 shown in FIG. 13. In this model, the spatial information is introduced to the prediction model by the GCN part and the temporal information is captured by the transformer units. At every time unit t, input \vec{xₜ} into the L-layer GCN model, every neural network layer in this GCN can be written as a non-linear function:

$$\vec{{h}^{( l + 1 )}} = f ( \hat{H} \vec{{h}^{( l )}} {W}^{l} )$$

where \vec{h⁽⁰⁾} is the input \vec{xₜ}, \vec{h^{(L)}} is the output of the graph layers, Ĥ=H+αI where α is a parameter to control the impact of the self-handover. Then after a FNN part, the output of the GCN module \vec{hₜ} is obtained and then input to a typical transformer unit. The transformer unit then outputs the prediction result.

Step 8: Train the neural network with the training set (Xₜᵣₐᵢₙ, Yₜᵣₐᵢₙ) and keep monitoring the mean square error on (Xᵥₐₗ, Yᵥₐₗ). Stop training when the mean square error (MSE) on (Xᵥₐₗ, Yᵥₐₗ) stops decreasing.

Step 9: Predict the active user number for the test data set Xₜₑₛₜ. Then compute the MSE of the neural network on the test set (Xₜₑₛₜ, Yₜₑₛₜ).

Although FIGS. 5 through 13 illustrate examples of a process 500 for relationship graph-based traffic prediction and related details, various changes may be made to FIGS. 5 through 13. For example, various components in FIGS. 5 through 13 could be combined, further subdivided, or omitted and additional components could be added according to particular needs. In addition, while shown as a series of steps, various operations in FIGS. 5 through 13 could overlap, occur in parallel, occur in a different order, or occur any number of times. In another example, steps may be omitted or replaced by other steps.

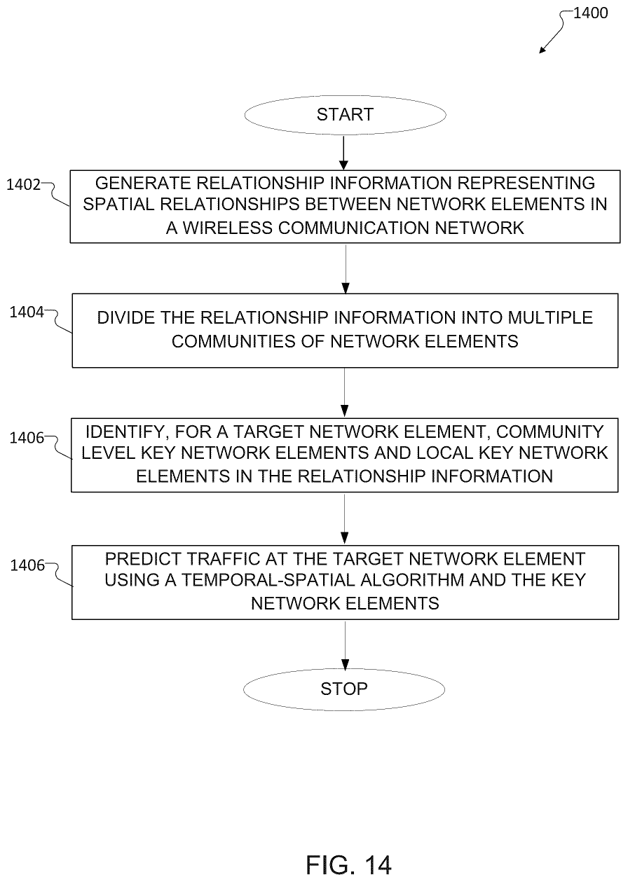

FIG. 14 illustrates a flow chart of a method 1400 for relationship graph-based traffic prediction according to various embodiments of the present disclosure, as may be performed by one or more components of the wireless network 100 (e.g., the gNB 102). The embodiment of the method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, the method 1400 begins at step 1402. At step 1402, relationship information is generated that represents spatial relationships between network elements in a wireless communication network. This could include, for example, the gNB 102 performing the NE relationship graph generation operation 501 to generate a relationship graph, such as the relationship graph 600.

At step 1404, the relationship information is divided into multiple communities of network elements, wherein network elements within each community have a higher correlation than network elements in different communities. This could include, for example, the gNB 102 performing the community discovery operation 502 to divide the relationship graph.

At step 1406, one or more community level key network elements and one or more local key network elements in the relationship information are identified for a target network element. This could include, for example, the gNB 102 performing the key NE identification operation 503 to identify one or more community level key network elements and one or more local key network elements.

At step 1408, traffic at the target network element is predicted using a temporal-spatial algorithm, wherein the temporal-spatial algorithm predicts the traffic based on temporal features derived from historical data and spatial features derived from the one or more community level key network elements and the one or more local key network elements. This could include, for example, the gNB 102 performing the TS prediction operation 504 to predict traffic at a target network element.

Although FIG. 14 illustrates one example of a method 1400 for relationship graph-based traffic prediction, various changes may be made to FIG. 14. For example, while shown as a series of steps, various steps in FIG. 14 could overlap, occur in parallel, occur in a different order, or occur any number of times.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method, comprising:
generating relationship information representing spatial relationships between network elements in a wireless communication network;
dividing the relationship information into multiple communities of network elements, wherein network elements within each community have a higher correlation than network elements in different communities;
identifying, for a target network element, one or more community level key network elements and one or more local key network elements in the relationship information; and
predicting traffic at the target network element using a temporal-spatial algorithm, wherein the temporal-spatial algorithm predicts the traffic based on temporal features derived from historical data and spatial features derived from the one or more community level key network elements and the one or more local key network elements.

2. The method of claim 1, wherein the relationship information is generated based on handovers that occur between pairs of network elements.

3. The method of claim 1, wherein the relationship information is generated using Pearson correlation coefficients between traffic variations of different network elements as edge weights.

4. The method of claim 1, wherein dividing the relationship information into the multiple communities of network elements comprises:
defining a target community size;
dividing the relationship information into the multiple communities, wherein each community includes a quantity of network elements;
determining how many communities of the multiple communities have a quantity of network elements less than the target community size; and
when a number of the communities having a quantity of network elements less than the target community size is less than a threshold amount, further dividing the relationship information into additional communities.

5. The method of claim 1, wherein identifying the one or more community level key network elements in the relationship information comprises:
determining a community that includes the target network element;
calculating centralities of all network elements in the community;
sorting the centralities of the network elements in the community; and
selecting the one or more community level key network elements based on an order of the sorted centralities.

6. The method of claim 1, wherein identifying the one or more local key network elements in the relationship information comprises:
calculating correlations between the target network element and its neighboring network elements;
sorting the calculated correlations; and
selecting the one or more local key network elements from the neighboring network elements based on an order of the sorted correlations.

7. The method of claim 1, wherein the temporal-spatial algorithm comprises a multi-layer perceptron (MLP)-based traffic prediction model or a graph convolutional neural network (GCN) and transformer-based prediction model.

8. A device comprising:
a transceiver; and
a processor operably connected to the transceiver, the processor configured to:
generate relationship information representing spatial relationships between network elements in a wireless communication network;
divide the relationship information into multiple communities of network elements, wherein network elements within each community have a higher correlation than network elements in different communities;
identify, for a target network element, one or more community level key network elements and one or more local key network elements in the relationship information; and
predict traffic at the target network element using a temporal-spatial algorithm, wherein the temporal-spatial algorithm predicts the traffic based on temporal features derived from historical data and spatial features derived from the one or more community level key network elements and the one or more local key network elements.

9. The device of claim 8, wherein the processor is configured to generate the relationship information based on handovers that occur between pairs of network elements.

10. The device of claim 8, wherein the processor is configured to generate the relationship information using Pearson correlation coefficients between traffic variations of different network elements as edge weights.

11. The device of claim 8, wherein to divide the relationship information into the multiple communities of network elements, the processor is configured to:
define a target community size;
divide the relationship information into the multiple communities, wherein each community includes a quantity of network elements;
determine how many communities of the multiple communities have a quantity of network elements less than the target community size; and
when a number of the communities having a quantity of network elements less than the target community size is less than a threshold amount, further divide the relationship information into additional communities.

12. The device of claim 8, wherein to identify the one or more community level key network elements in the relationship information, the processor is configured to:
determine a community that includes the target network element;
calculate centralities of all network elements in the community;
sort the centralities of the network elements in the community; and
select the one or more community level key network elements based on an order of the sorted centralities.

13. The device of claim 8, wherein to identify the one or more local key network elements in the relationship information, the processor is configured to:
calculate correlations between the target network element and its neighboring network elements;
sort the calculated correlations; and
select the one or more local key network elements from the neighboring network elements based on an order of the sorted correlations.

14. The device of claim 8, wherein the temporal-spatial algorithm comprises a multi-layer perceptron (MLP)-based traffic prediction model or a graph convolutional neural network (GCN) and transformer-based prediction model.

15. A non-transitory computer readable medium comprising program code that, when executed by a processor of a device, causes the device to:
generate relationship information representing spatial relationships between network elements in a wireless communication network;
divide the relationship information into multiple communities of network elements, wherein network elements within each community have a higher correlation than network elements in different communities;
identify, for a target network element, one or more community level key network elements and one or more local key network elements in the relationship information; and
predict traffic at the target network element using a temporal-spatial algorithm, wherein the temporal-spatial algorithm predicts the traffic based on temporal features derived from historical data and spatial features derived from the one or more community level key network elements and the one or more local key network elements.

16. The non-transitory computer readable medium of claim 15, wherein the program code causes the processor to generate the relationship information based on handovers that occur between pairs of network elements.

17. The non-transitory computer readable medium of claim 15, wherein the program code causes the processor to generate the relationship information using Pearson correlation coefficients between traffic variations of different network elements as edge weights.

18. The non-transitory computer readable medium of claim 15, wherein the program code to divide the relationship information into the multiple communities of network elements comprises program code to:
define a target community size;
divide the relationship information into the multiple communities, wherein each community includes a quantity of network elements;
determine how many communities of the multiple communities have a quantity of network elements less than the target community size; and
when a number of the communities having a quantity of network elements less than the target community size is less than a threshold amount, further divide the relationship information into additional communities.

19. The non-transitory computer readable medium of claim 15, wherein the program code to identify the one or more community level key network elements in the relationship information comprises program code to:
determine a community that includes the target network element;
calculate centralities of all network elements in the community;
sort the centralities of the network elements in the community; and
select the one or more community level key network elements based on an order of the sorted centralities.

20. The non-transitory computer readable medium of claim 15, wherein the program code to identify the one or more local key network elements in the relationship information comprises program code to:
calculate correlations between the target network element and its neighboring network elements;
sort the calculated correlations; and
select the one or more local key network elements from the neighboring network elements based on an order of the sorted correlations.
